(19) United States
(12) Patent Application Publication
(10) Pub. No.: US 2026/0361393 A1
(43) Pub. Date: Nov. 12, 2026

(54) PERFORMANCE MEASUREMENTS AND FUNCTION PLACEMENT IN 6G NETWORKS

(71) Applicant: Intel Corporation, Santa Clara, CA (US)

(72) Inventors: Thomas Luetzenkirchen, Taufkirchen (DE); Markus Domink Mueck, Unterhaching (DE); Dario Sabella, Gassino (IT)

(21) Appl. No.: 19/126,439

(22) PCT Filed: Dec. 8, 2023
(86) PCT No.: PCT/US2023/083138

§ 371 Date: May 1, 2025

Related U.S. Application Data
(60) Provisional application No. 63/439,784, filed on Jan. 18, 2023.
(60) Provisional application No. 63/439,823, filed on Jan. 18, 2023.

(51) Int. Cl. H04B 7/185; H04L 43/0829; H04W 60/00

(52) U.S. Cl. CPC H04B 7/18513; H04L 43/0841; H04W 60/00

(57) ABSTRACT

A computer-readable storage medium stores instructions for execution by one or more processors of a network function (NF) node. The instructions to configure the NF node for communication with a core network in a 6G and beyond network, and cause the NF node to decode UL data received at a user plane function (UPF) of the NF node from a radio access network (RAN). The UL data originates from a UE in communication with the RAN. The UL data is encoded for retransmission to a core network of the 6G and beyond network via a satellite communication link. DL data received from a UPF of the core network via the satellite communication link in response to the retransmission of the UL data is decoded. The DL data originates from a data network of the core network.

### PRIORITY CLAIM

This application claims the benefit of priority to the following provisional applications:

U.S. Provisional Patent Application No. 63/439,784, filed Jan. 18, 2023, and entitled “ADVANCED PERFORMANCE MEASUREMENTS AND ADAPTIVE PACKET PROCESSING IN COMMUNICATION NETWORKS;” and

U.S. Provisional Patent Application No. 63/439,823, filed Jan. 18, 2023, and entitled “LATENCY-AWARE NETWORK FUNCTION (NF) FUNCTION PLACEMENT FOR EDGE COMPUTING IN SATELLITE BACKHAUL AND FRONTHAUL SCENARIOS AND ARTIFICIAL-INTELLIGENCE (AI)-BASED ACCESS SELECTION.”

Each of the above-listed provisional applications is incorporated herein by reference in its entirety.

### BACKGROUND

Mobile communications have evolved significantly from early voice systems to today's highly sophisticated integrated communication platform. With the increase in different types of devices communicating with various network devices, the usage of 3GPP LTE systems has increased. The penetration of mobile devices (user equipment or UEs) in modern society has continued to drive demand for a wide variety of networked devices in many disparate environments. Fifth-generation (5G), Sixth-Generation (6G) (and beyond) wireless systems are forthcoming and are expected to enable even greater speed, connectivity, and usability. Next-generation (e.g., 5G, 6G, etc.) networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As the current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC) or DC-based LAA and the standalone LTE system in the unlicensed spectrum, according to which LTE-based technology solely operates in the unlicensed spectrum without requiring an “anchor” in the licensed spectrum, called MulteFire. Further enhanced operation of LTE and NR systems in the licensed as well as unlicensed spectrum is expected in future releases and 6G systems. Such enhanced operations can include techniques for advanced performance measurements and adaptive packet processing in 6G networks. Additional enhanced operations include techniques for latency-aware NF function for edge computing in satellite backhaul and fronthaul scenarios and artificial intelligence (AI)-based access selection.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2, FIG. 3, and FIG. 4 illustrate various systems, devices, and components that may implement aspects of disclosed embodiments.

FIG. 5 illustrates a 5G system with a satellite backhaul, in accordance with some aspects.

FIG. 6 illustrates an architecture overview with edge-based content storage and request handling, in accordance with some aspects.

FIG. 7 illustrates satellite edge computing via UPF on-board, in accordance with some aspects.

FIG. 8 illustrates edge computing with satellite backhaul and latency-aware NF function placement, in accordance with some aspects.

FIG. 9 illustrates the registration and PDU session establishment procedure, in accordance with some aspects.

FIG. 10 illustrates satellite edge computing with latency-aware NF function placement, in accordance with some aspects.

FIG. 11 illustrates an AI system architecture in accordance with the European (Draft) AI Act., in accordance with some aspects.

FIG. 12 illustrates a functional architecture interconnecting entities of an AI system architecture through a bus., in accordance with some aspects.

FIG. 13 illustrates interactions of entities of an AI architecture in connection with the avoidance of undesired biases, in accordance with some aspects.

FIG. 14 illustrates a simplified diagram of interactions of entities of an AI architecture in connection with the avoidance of undesired biases, in accordance with some aspects.

FIG. 15 illustrates interactions of entities of an AI architecture in connection with the replacement of failing/misbehaving components/entities, in accordance with some aspects.

FIG. 16 illustrates Access Traffic Steering, Switch, and Splitting (ATSSS) support in a 5G system architecture, in accordance with some aspects.

FIG. 17 illustrates an advanced ATSSS architecture supporting end-to-end network programmability, in accordance with some aspects.

FIG. 18 illustrates a block diagram of a communication device such as an evolved Node-B (eNB), a new generation Node-B (gNB) (or another RAN node), a satellite node, an NCR, an access point (AP), a wireless station (STA), a mobile station (MS), or user equipment (ULE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for those of other aspects. Aspects outlined in the claims encompass all available equivalents of those claims.

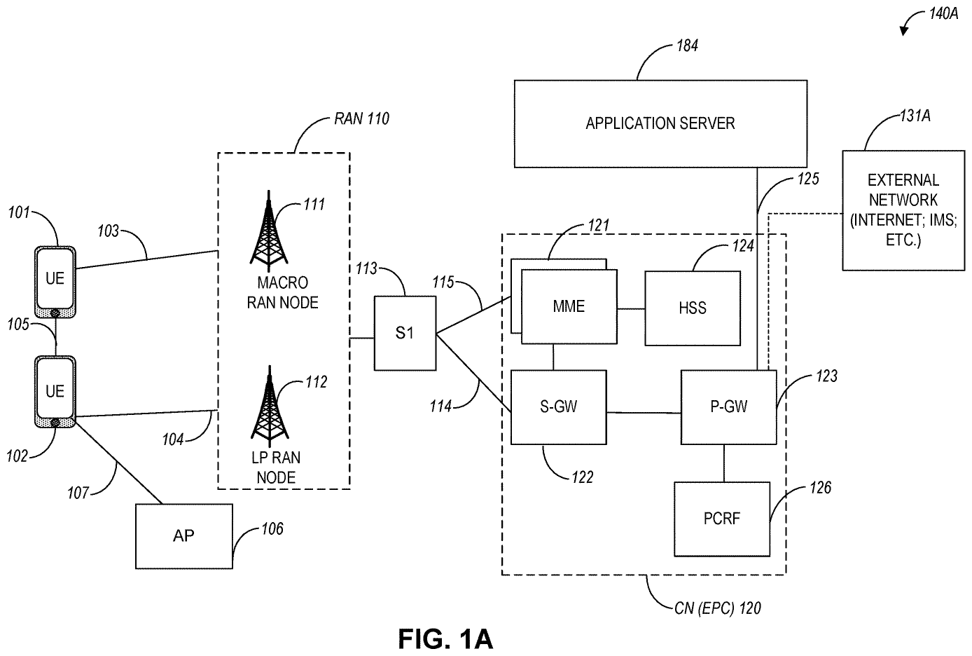

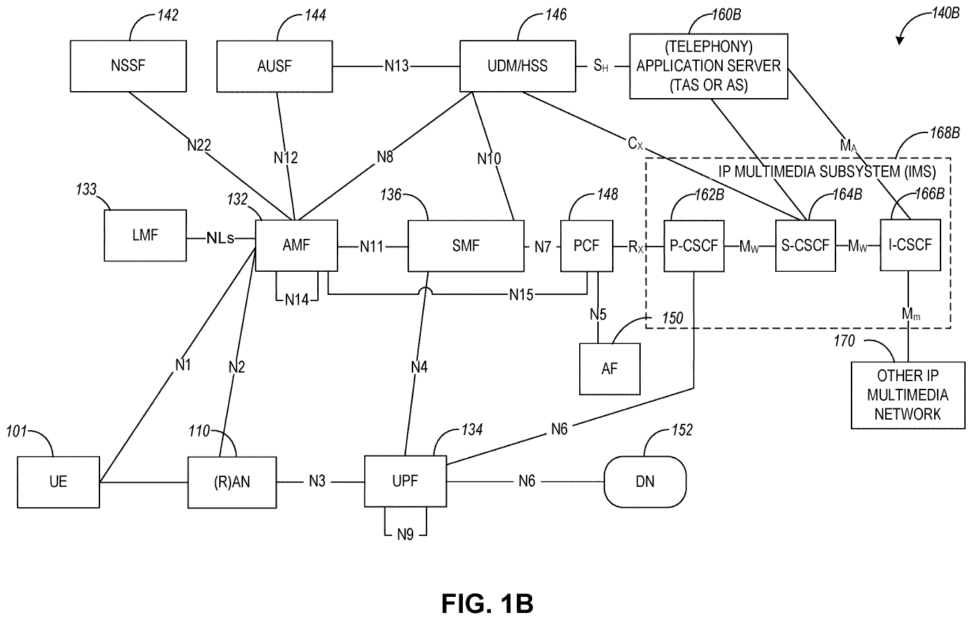

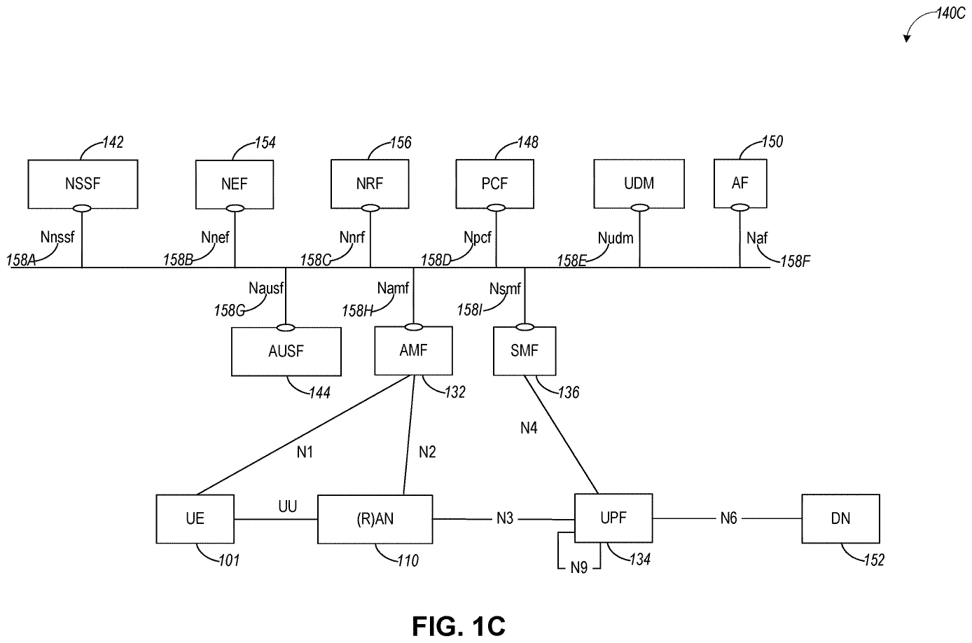

FIG. 1A illustrates an architecture of a network in accordance with some aspects. The communication network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. UE 101 and UE 102 can be collectively referred to herein as UE 101, and UE 101 can be used to perform one or more of the techniques disclosed herein.

Any of the radio links described herein (e.g., as used in the communication network 140A or any other illustrated network) may operate according to any exemplary radio communication technology and/or standard.

LTE and LTE-Advanced are standards for wireless communications of high-speed data for UE, such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme, including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC), OFDMA, etc.) and, in particular, 3GPP NR (New Radio) by allocating the OFDM carrier data bit vectors to the corresponding symbol resources.

In some aspects, any of the UE 101 and UE 102 can comprise an Internet-of-Things (IoT) UE or a Cellular IoT (CIoT) UE, which can comprise a network access layer designed for low-power IoT applications utilizing short-lived UE connections. In some aspects, any of the UE 101 and UE 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure) with short-lived connections. The IoT UEs may execute background applications (e.g., keep-alive messages, status updates, etc.) to facilitate the connections of the IoT network.

In some aspects, any of the UE 101 and UE 102 can include enhanced MTC (eMTC) UEs or further enhanced MTC (FeMTC) UEs.

The UE 101 and UE 102 may be configured to connect, e.g., communicatively coupled, with a radio access network (RAN) 110. The RAN 110 may be, for example, a Universal Mobile Telecommunications System (UMTS), an Evolved Universal Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. Connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable connections 103 and 104. These access nodes (ANs) can be referred to as base stations (BSs), NodeBs, evolved NodeBs (eNBs), Next Generation NodeBs (gNBs), RAN network nodes, and the like, and can comprise ground stations (e.g., terrestrial access points) or satellite stations providing coverage within a geographic area (e.g., a cell). In some aspects, communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN nodes, and one or more RAN nodes for providing femtocells or picocells (e.g., cells having smaller coverage areas, smaller user capacity, or higher bandwidth compared to macrocells), e.g., low power (LP) RAN node or an unlicensed spectrum based secondary RAN node.

Any of the communication nodes 111 and 112 can terminate the air interface protocol and can be the first point of contact for UE 101 and UE 102. In some aspects, any of the communication nodes 111 and 112 can fulfill various logical functions for the RAN 110, including, but not limited to, the radio network controller (RNC) functions such as radio bearer management, uplink, and downlink dynamic radio resource management, and data packet scheduling, and mobility management. In an example, any of the communication nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in FIGS. 1B-1C). In this aspect, the S1 interface 113 is split into two parts: the S1-U interface 114, which carries user traffic data between the communication nodes 111 and 112 and the serving gateway (S-GW) 122, and the S1-mobility management entity (MME) interface 115, which is a signaling interface between the communication nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access, such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110 and route data packets between the RAN 110 and the CN 120. In addition, the S-GW 122 may be a local mobility anchor point for inter-RAN node handovers and may also provide an anchor for inter-3GPP mobility. Other responsibilities of the S-GW 122 may include lawful intercept, charging, and some policy enforcement.

The P-GW 123 may terminate an SGi interface toward a PDN. The P-GW 123 may route data packets between the EPC network (e.g., CN 120) and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband IoT (NB-IoT).

An NG system architecture can include the RAN 110 and a 5G core network (e.g., CN 120). RAN 110 in an NG system can be referred to as NG-RAN. The RAN 110 can include a plurality of nodes, such as gNBs and NG-eNBs. The CN 120 (also referred to as a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces and the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, a RAN network node, and so forth. In some aspects, a gNB can be a master node (MN), and NG-eNB can be a secondary node (SN) in a 5G architecture. In some aspects, the master/primary node may operate in a licensed band, and the secondary node may operate in an unlicensed band.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, location management function (LMF) 133, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The LMF 133 may be used in connection with 5G positioning functionalities. In some aspects, LMF 133 receives measurements and assistance information from the RAN 110 and the mobile device (e.g., UE 101) via the AMF 132 over the NLs interface to compute the position of the UE 101. In some aspects, NR positioning protocol A (NRPPa) may be used to carry the positioning information between NG-RAN and LMF 133 over a next-generation control plane interface (NG-C). In some aspects, LMF 133 configures the UE using the LTE positioning protocol (LPP) via AMF 132. The RAN 110 configures the UE 101 using radio resource control (RRC) protocol over LTE-Uu and NR-Uu interfaces.

In some aspects, the 5G system architecture 140B configures different reference signals to enable positioning measurements. Example reference signals that may be used for positioning measurements include the positioning reference signal (NR PRS) in the downlink and the sounding reference signal (SRS) for positioning in the uplink. The downlink positioning reference signal (PRS) is a reference signal configured to support downlink-based positioning methods.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1), or interrogating CSCF (I-CSCF) 166B. The P-CSCF 162B can be configured to be the first contact point for the UE 102 within the IMS 168B. The S-CSCF 164B can be configured to handle the session states in the network, and the E-CSCF can be configured to handle certain aspects of emergency sessions, such as routing an emergency request to the correct emergency center or PSAP. The I-CSCF 166B can be configured to function as the contact point within an operator's network for all IMS connections destined to a subscriber of that network operator or a roaming subscriber currently located within that network operator's service area. In some aspects, the I-CSCF 166B can be connected to another IP multimedia network 170, e.g., an IMS operated by a different network operator.

In some aspects, the UDM/HSS 146 can be coupled to an application server (AS) 160B, which can include a telephony application server (TAS) or another AS. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, the 5G system architecture 140C can also include a network exposure function (NEF) 154 and a network repository function (NRF) 156. In some aspects, 5G system architectures can be service-based, and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

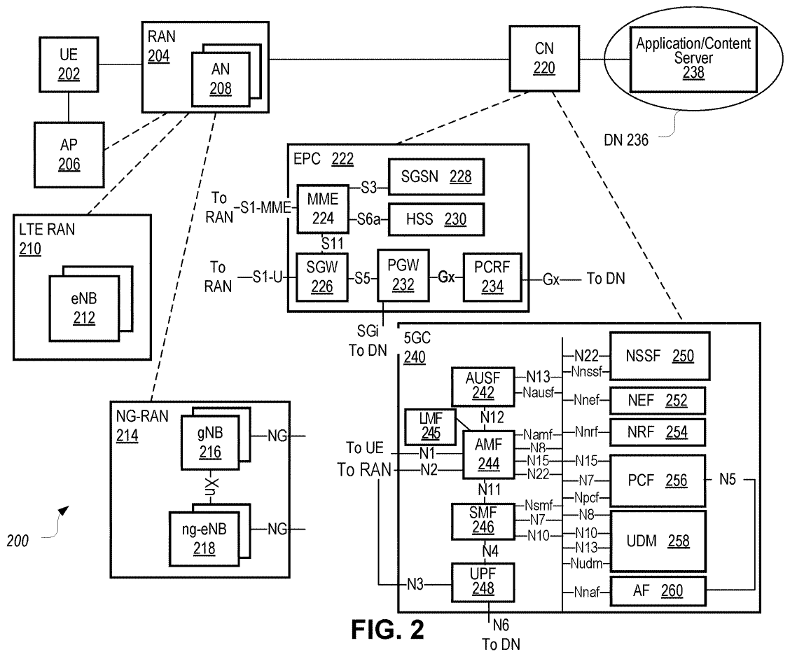

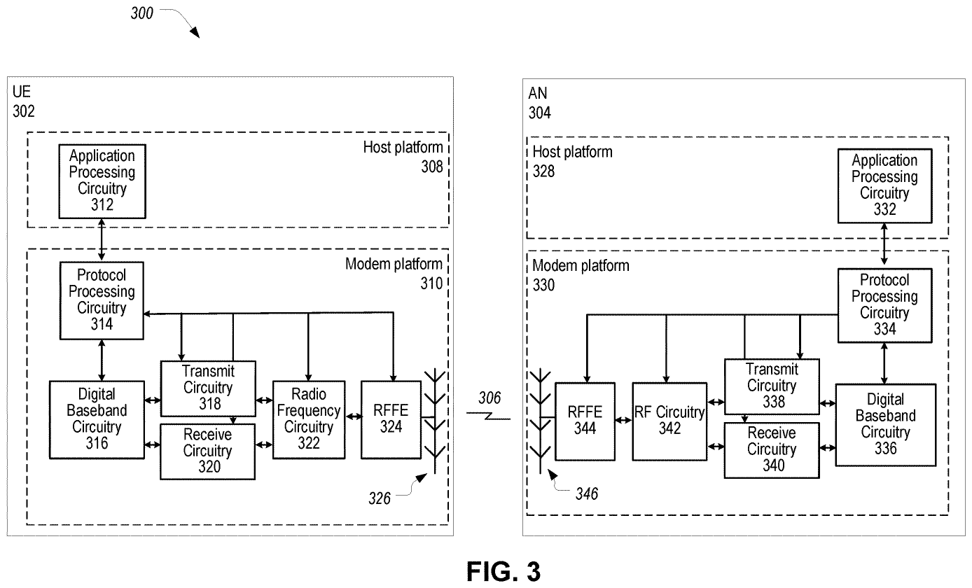

FIGS. 2-18 illustrate various systems, devices, and components that may implement aspects of disclosed embodiments in different communication systems, such as 5G-NR and beyond (e.g., 6G) networks, including non-terrestrial networks (NTNs). UEs, base stations (such as gNBs), and/or other nodes (e.g., satellites or other NTN nodes) discussed herein can be configured to perform the disclosed techniques.

FIG. 2 illustrates a network 200 in accordance with various embodiments. The network 200 may operate in a manner consistent with 3GPP technical specifications for LTE or 5G/NR systems. However, the example embodiments are not limited in this regard, and the described embodiments may apply to other networks that benefit from the principles described herein, such as future 3GPP systems or the like.

The network 200 may include a UE 202, which may include any mobile or non-mobile computing device designed to communicate with a RAN 204 via an over-the-air connection. The UE 202 may be, but is not limited to, a smartphone, tablet computer, wearable computing device, desktop computer, laptop computer, in-vehicle infotainment, in-car entertainment device, instrument cluster, a head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, network 200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 configured by the RAN 204 to utilize both cellular radio resources and WLAN resources.

The RAN 204 may include one or more access nodes, for example, access node (AN) 208. AN 208 may terminate air-interface protocols for the UE 202 by providing access stratum protocols, including RRC, Packet Data Convergence Protocol (PDCP), Radio Link Control (RLC), MAC, and L1 protocols. In this manner, the AN 208 may enable data/voice connectivity between the core network (CN) 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 can be referred to as a BS, gNB, RAN node, eNB, ng-eNB, NodeB, RSU, TRxP, TRP, etc. The AN 208 may be a macrocell base station or a low-power base station for providing femtocells, picocells, or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc., to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG, and a second AN may be a secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/SCells. Before accessing the unlicensed spectrum, the nodes may perform medium/carrier-sensing operations based on, for example, a listen-before-talk (LBT) protocol.

In V2X scenarios, the UE 202 or AN 208 may be or act as a roadside unit (RSU), which may refer to any transportation infrastructure entity used for V2X communications. An RSU may be implemented in or by a suitable AN or a stationary (or relatively stationary) UE. An RSU implemented in or by a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, and media, as well as applications/software to sense and control ongoing vehicular and pedestrian traffic. The RSU may provide very low latency communications required for high-speed events, such as crash avoidance, traffic warnings, and the like. Additionally, or alternatively, the RSU may provide other cellular/WLAN communications services. The components of the RSU may be packaged in a weatherproof enclosure suitable for outdoor installation and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: sub-carrier spacing (SCS) of 15 kHz; CP-OFDM waveform for downlink (DL) and SC-FDMA waveform for uplink (UL); turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operate on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface but may connect with a UE via an LTE air interface. The gNB 216 and the ng-eNB 218 may connect over an Xn interface.

In some embodiments, the NG interface may be split into two parts: an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN214 and an AMF 244 (e.g., N2 interface).

The NG-RAN 214 may provide a 5G-NR air interface with the following characteristics: variable SCS; CP-OFDM for DL, CP-OFDM, and DFT-s-OFDM for UL; polar, repetition, simplex, and Reed-Muller codes for control and LDPC for data. The 5G-NR air interface may rely on CSI-RS and PDSCH/PDCCH DMRS, similar to the LTE air interface. The 5G-NR air interface may not use a CRS but may use PBCH DMRS for PBCH demodulation, PTRS for phase tracking for PDSCH, and tracking reference signal for time tracking. The 5G-NR air interface may operate on FR1 bands that include sub-6 GHz bands or FR2 bands that include bands from 24.25 GHz to 52.6 GHz. The 5G-NR air interface may include a synchronization signal and physical broadcast channel (SS/PBCH) block (SSB), which is an area of a downlink resource grid that includes PSS/SSS/PBCH.

In some embodiments, the 5G-NR air interface may utilize BWPs (bandwidth parts) for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amounts of frequency resources (for example, PRBs) to support data transmission under different traffic loading scenarios. A BWP containing a smaller number of PRBs can be used for data transmission with a small traffic load while allowing power saving at the UE 202 and, in some cases, at the gNB 216. A BWP containing a larger number of PRBs can be used for scenarios with higher traffic loads.

The RAN 204 is communicatively coupled to CN 220, which includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be connected to the LTE radio network as part of the Enhanced Packet System (EPS) 222, which may also be referred to as an EPC (or enhanced packet core). The EPC 222 may include MME 224, SGW 226, SGSN 228, HSS 230, PGW 232, and PCRF 234 coupled with one another over interfaces (or “reference points”) as shown. Functions of the elements of the EPC 222 may be briefly introduced as follows.

The MME 224 may implement mobility management functions to track the current location of the UE 202 to facilitate paging, bearer activation/deactivation, handovers, gateway selection, authentication, etc.

The SGW 226 may terminate an S1 interface toward the RAN and route data packets between the RAN and the EPC 222. The SGW 226 may be a local mobility anchor point for inter-RAN node handovers and may also provide an anchor for inter-3GPP mobility. Other responsibilities may include lawful intercept, charging, and some policy enforcement.

The SGSN 228 may track the location of the UE 202 and perform security functions and access control. In addition, the SGSN 228 may perform inter-EPC node signaling for mobility between different RAT networks, PDN and S-GW selection as specified by MME 224, MME selection for handovers, etc. The S3 reference point between the MME 224 and the SGSN 228 may enable user and bearer information exchange for inter-3GPP access network mobility in idle/active states.

The HSS 230 may include a database for network users, including subscription-related information to support the network entities' handling of communication sessions. The HSS 230 can provide support for routing/roaming, authentication, authorization, naming/addressing resolution, location dependencies, etc. An S6a reference point between the HSS 230 and the MME 224 may enable the transfer of subscription and authentication data for authenticating/authorizing user access to the LTE CN (e.g., CN 220).

The PGW 232 may terminate an SGi interface toward a data network (DN) 236 that may include an application/content server 238. The PGW 232 may route data packets between the LTE CN and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for the provision of IMS services. The PGW 232 may be coupled with a PCRF 234 via a Gx reference point.

The PCRF 234 is the policy and charging control element of the CN 220. The PCRF 234 may be communicatively coupled to the app/content server 238 to determine appropriate QoS and charging parameters for service flows. The PCRF 234 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for the authentication of UE 202 and handle authentication-related functionality. The AUSF 242 may facilitate a common authentication framework for various access types. In addition to communicating with other elements of the 5GC 240 over reference points, as shown, the AUSF 242 may exhibit a Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246 and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244, and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and quality of service; lawful intercept (for SM events and interface to LI system); termination of SM parts of NAS messages; downlink data notification; initiating AN specific SM information, sent via AMF 244 over N2 to AN 208; and determining SSC mode of a session. SM may refer to the management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnecting to data network 236, and a branching point to support multi-homed PDU sessions. The UPF 248 may also perform packet routing and forwarding, perform packet inspection, enforce the user plane part of policy rules, lawfully intercept packets (UP collection), perform traffic usage reporting, perform quality of service handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs if needed. The NSSF 250 may also determine the AMF set to be used to serve the UE 202 or a list of candidate AMFs based on a suitable configuration and possibly by querying the NRF 254. The selection of a set of network slice instances for the UE 202 may be triggered by the AMF 244, with which the UE 202 is registered by interacting with the NSSF 250, which may lead to a change of AMF. The NSSF 250 may interact with the AMF 244 via an N22 reference point and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for the third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on the exposed capabilities of other NFs. This information may be stored at the NEF 252 as structured data or a data storage NF using standardized interfaces. The stored information can then be re-exposed by the NEF 252 to other NFs and AFs or used for other purposes, such as analytics. Additionally, the NEF 252 may exhibit a Nnef service-based interface.

The NRF 254 may support service discovery functions, receive NF discovery requests from NF instances, and provide information on the discovered NF instances to the NF instances. NRF 254 also maintains information on available NF instances and their supported services. As used herein, the terms “instantiate,” “instantiation,” and the like may refer to the creation of an instance, and an “instance” may refer to a concrete occurrence of an object, which may occur, for example, during the execution of program code. Additionally, the NRF 254 may exhibit the Nnrf service-based interface.

The PCF 256 may provide policy rules to control plane functions to enforce them and may also support a unified policy framework to govern network behavior. The PCF 256 may also implement a front end to access subscription information relevant to policy decisions in a UDR of the UDM 258. In addition to communicating with functions over reference points, as shown, the PCF 256 exhibits an Npcf service-based interface.

The UDM 258 may handle subscription-related information to support the network entities' handling of communication sessions and may store the subscription data of UE 202. For example, subscription data may be communicated via an N8 reference point between the UDM 258 and the AMF 244. The UDM 258 may include two parts: an application front end and a UDR. The UDR may store subscription data and policy data for the UDM 258 and the PCF 256, and/or structured data for exposure and application data (including PFDs for application detection and application request information for multiple UE) for the NEF 252. The Nudr service-based interface may be exhibited by the UDR to allow the UDM 258, PCF 256, and NEF 252 to access a particular set of the stored data, as well as to read, update (e.g., add, modify), delete, and subscribe to the notification of relevant data changes in the UDR. The UDM may include a UDM-FE, which is in charge of processing credentials, location management, subscription management, and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points, as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3rd party services to be geographically close to the point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re)selection and traffic routing. Based on operator deployment, when AF 260 is considered to be a trusted entity, the network operator may permit AF 260 to interact directly with relevant NFs. Additionally, the AF 260 may exhibit a Naf service-based interface.

The data network 236 may represent various network operator services, Internet access, or third-party services that may be provided by one or more servers, including, for example, application/content server 238.

In some aspects, network 200 is configured for NR positioning using the location management function (LMF) 245, which can be configured as an LMF node or as functionality in a different type of node. In some embodiments, LMF 245 is configured to receive measurements and assistance information from NG-RAN 214 and UE 202 via the AMF 244 (e.g., using an NLs interface) to compute the position of the UE. In some embodiments, the NR positioning protocol A (NRPPa) can be used to carry the positioning information between NG-RAN 214 and LMF 245 over a next-generation control plane interface (NG-C). In some embodiments, LMF 245 configures the UE 202 using LTE positioning protocol (LPP) (e.g., LPP-based communication link) via the AMF 244. In some aspects, NG-RAN 214 configures the UE 202 using, e.g., radio resource control (RRC) protocol signaling over, e.g., LTE-Uu and NR-Uu interfaces. In some aspects, UE 202 uses the LTE-Uu interface to communicate with the ng-eNB 218 and the NR-Uu interface to communicate with the gNB 216. In some aspects, ng-eNB 216 and gNB 216 use NG-C interfaces to communicate with the AMF 244.

In some embodiments, the following reference signals can be used to achieve positioning measurements in NR communication networks: NR positioning reference signal (NR PRS) in the downlink and sounding reference signal (SRS) for positioning in the uplink. The downlink positioning reference signal (PRS) can be used as a reference signal supporting downlink-based positioning techniques. In some aspects, the entire NR bandwidth can be covered by transmitting PRS over multiple symbols that can be aggregated to accumulate power.

FIG. 3 schematically illustrates a wireless network 300 in accordance with various embodiments. The wireless network 300 may include a UE 302 in wireless communication with AN 304. The UE 302 and AN 304 may be similar to, and substantially interchangeable with, like-named components described elsewhere herein.

The UE 302 may be communicatively coupled with the AN 304 via connection 306. Connection 306 is illustrated as an air interface to enable communicative coupling and can be consistent with cellular communications protocols such as an LTE protocol or a 5G NR protocol operating at mmWave or sub-6 GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example, UDP) and Internet (for example, IP) operations.

The protocol processing circuitry 314 may implement one or more layer operations to facilitate the transmission or reception of data over connection 306. The layer operations implemented by the protocol processing circuitry 314 may include, for example, MAC, RLC, PDCP, RRC, and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and one or more antenna panels 326 (referred to generically as “transmit/receive components”) may be specific to details of a specific implementation such as, for example, whether the communication is TDM or FDM, in mmWave or sub-6 GHz frequencies, etc. In some embodiments, the transmit/receive components may be arranged in multiple parallel transmit/receive chains, may be disposed of in the same or different chips/modules, etc.

In some embodiments, the protocol processing circuitry 314 may include one or more instances of control circuitry (not shown) to provide control functions for the transmit/receive components.

A UE reception may be established by and via the one or more antenna panels 326, RFFE 324, RF circuitry 322, receive circuitry 320, digital baseband circuitry 316, and protocol processing circuitry 314. In some embodiments, the one or more antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and one or more antenna panels 326. In some embodiments, the transmit components of the UE 302 may apply a spatial filter to the data to be transmitted to form a transmit beam emitted by the antenna elements of the one or more antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with the like-named components of the UE 302. In addition to performing data transmission/reception as described above, the components of the AN 304 may perform various logical functions that include, for example, RNC functions such as radio bearer management, uplink and downlink dynamic radio resource management, and data packet scheduling.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400, including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The one or more processors 410 may include, for example, a processor 412 and a processor 414. The one or more processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include a main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The one or more communication resources 430 may include interconnection or network interface controllers, components, or other suitable devices to communicate with one or more peripheral devices 404 or one or more databases 406 or other network elements via a network 408. For example, the one or more communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the one or more processors 410 to perform any one or more of the methodologies discussed herein. The instructions 450 may reside, completely or partially, within at least one of the one or more processors 410 (e.g., within the processor's cache memory), the memory/storage devices 420, or any suitable combination thereof. Furthermore, any portion of the instructions 450 may be transferred to the hardware resources 400 from any combination of the one or more peripheral devices 404 or the one or more databases 406. Accordingly, the memory of the one or more processors 410, the memory/storage devices 420, the one or more peripheral devices 404, and the one or more databases 406 are examples of computer-readable and machine-readable media.

For one or more embodiments, at least one of the components outlined in one or more of the preceding figures may be configured to perform one or more operations, techniques, processes, and/or methods as outlined in the example sections below. For example, baseband circuitry associated with one or more of the preceding figures may be configured to operate in accordance with one or more of the examples set forth below. For another example, circuitry associated with a UE, base station, satellite, network element, etc., as described above in connection with one or more of the preceding figures may be configured to operate in accordance with one or more of the examples set forth below in the example section.

The term “application” may refer to a complete and deployable package or environment to achieve a specific function in an operational environment. The term “AI/ML application” or the like may be an application that contains some artificial intelligence (AI)/machine learning (ML) models and application-level descriptions. In some embodiments, an AI/ML application may be used for configuring or implementing one or more of the disclosed aspects.

The term “machine learning” or “ML” refers to the use of computer systems implementing algorithms and/or statistical models to perform a specific task(s) without using explicit instructions but instead relying on patterns and inferences. ML algorithms build or estimate mathematical model(s) (referred to as “ML models” or the like) based on sample data (referred to as “training data,” “model training information,” or the like) to make predictions or decisions without being explicitly programmed to perform such tasks. Generally, an ML algorithm is a computer program that learns from experience concerning some task, and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms, as discussed herein, may be used interchangeably for the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.), unsupervised learning (e.g., K-means clustering, principal component analysis (PCA), etc.), reinforcement learning (e.g., Q-learning, multi-armed bandit learning, deep RL, etc.), neural networks, and the like. Depending on the implementation, a specific ML model could have many sub-models as components, and the ML model may train all sub-models together. Separately trained ML models can also be chained together in an ML pipeline during inference. An “ML pipeline” is a set of functionalities, functions, or functional entities specific to an ML-assisted solution; an ML pipeline may include one or several data sources in a data pipeline, a model training pipeline, a model evaluation pipeline, and an actor. The “actor” is an entity that hosts an ML-assisted solution using the output of the ML model inference). The term “ML training host” refers to an entity, such as a network function, that hosts the training of the model. The term “ML inference host” refers to an entity, such as a network function, that hosts the model during inference mode (which includes both the model execution as well as any online learning, if applicable). The ML host informs the actor about the output of the ML algorithm, and the actor decides on an action (an “action” is performed by an actor as a result of the output of an ML-assisted solution). The term “model inference information” refers to information used as an input to the ML model for determining inference(s); the data used to train an ML model and the data used to determine inferences may overlap, however, “training data” and “inference data” refer to different concepts.

3GPP TR 23.737 specifies a scenario for the usage of a satellite backhaul between the core and terrestrial access network providing transport for the N1/N2/N3 reference points. The satellite system transparently carries the communication payload of the 3GPP reference points.

In this scenario, edge computing can be supported by collocating a user plane function (UPF) with the terrestrial access network, allowing for efficient service delivery through the reduced end-to-end latency and load on the transport network (e.g., reducing traffic on the satellite backhaul).

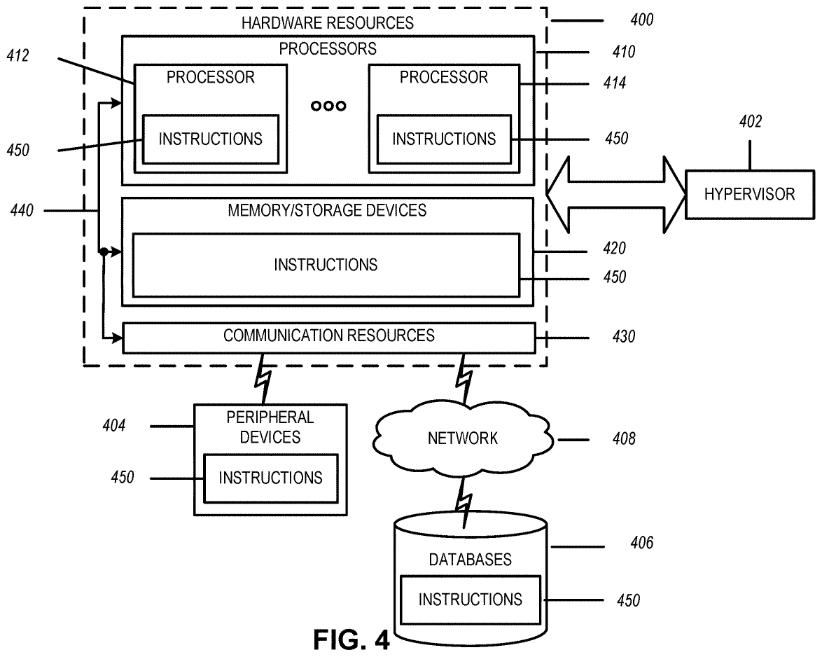

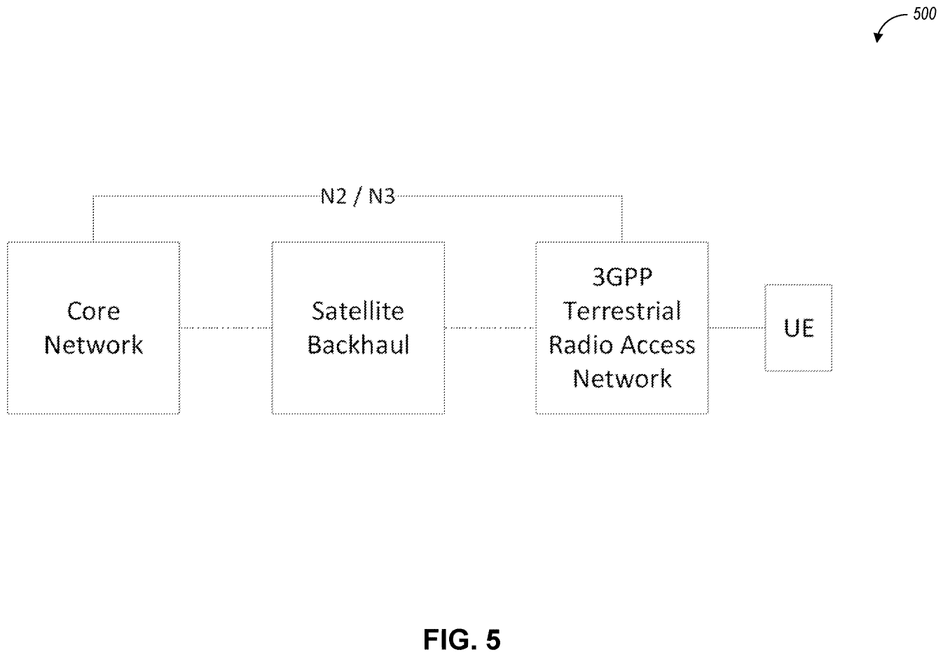

FIG. 5 illustrates diagram 500 of a 5G system with a satellite backhaul, in accordance with some aspects.

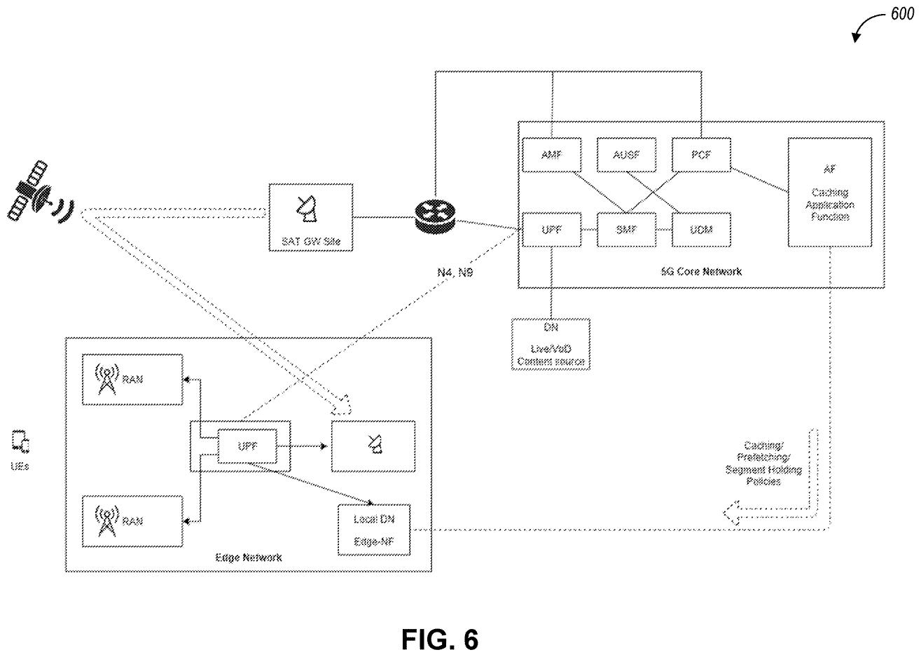

FIG. 6 illustrates diagram 600 of an architecture overview with edge-based content storage and request handling, in accordance with some aspects.

In FIG. 6, a network function at the edge (edge NF) is capable of storing content files (e.g., video segments in HTTP-based video streaming applications) provided by a core data network (CDN) server through a satellite link and making them available at the edge cache.

In FIG. 6, the UPF in the edge network exposes the N4 and N9 interface over the satellite link (feeder link and service link) towards the core network. For a specific PDU session, a single SMF in the core network controls the UPFs in the edge network and the core network.

However, besides the achieved optimization in efficient service delivery, this solution requires forwarding of a significant amount of control messages message (e.g., N2/NGAP, N4/PFCP) over the satellite link (feeder link and service link), which has the following issues:
(a) Satellite systems feature much larger propagation delays than terrestrial systems. According to TR 38.811, the one-way delay between the satellite-gateway (edge) and satellite-gateway (CN) may reach up to 274 ms for Geostationary Synchronous Orbit (GSO) systems and is greater than 15.5 ms for Non-Geosynchronous Orbit (NGSO) systems.
(b) The Local Offload Split Model measurements performed in a testbed using a GEO satellite backhaul indicate that, e.g., the Registration and PDU session establishment procedures observe a significant delay compared to an ethernet backhaul, as seen in Table 1 below.

TABLE 1

| | | | | | Control: |
|---|---|---|---|---|---|
| | | PDU Session | PFCP | | Backhaul |
| Procedure | Register | Establishment | Messages | Deregister | RTT |
| With | 1369 | 1415 | 630 | 1320 | 582 |
| satellite | | | | | |
| backhaul | | | | | |
| (ms) | | | | | |
| With | 16.7 | 42.8 | 2.6 | 14 | 2 |
| Ethernet | | | | | |
| backhaul | | | | | |
| (ms) | | | | | |

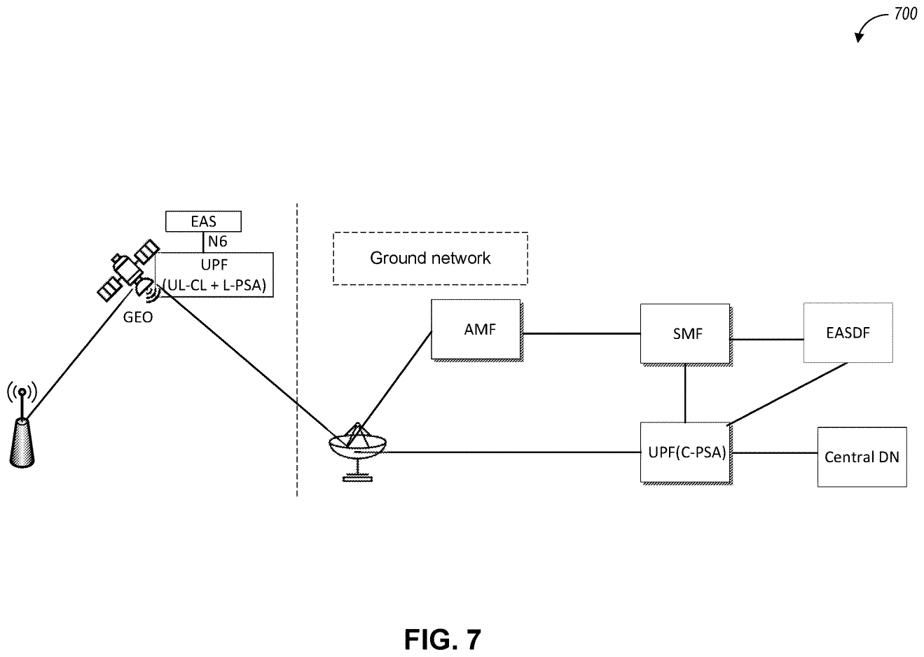

A second scenario addressed in this IDF is a satellite fronthaul scenario, as illustrated in FIG. 7, where a UPF is deployed on a GEO satellite with gNB on board as specified in TR 23.700-27.

FIG. 7 illustrates a diagram 700 of satellite edge computing via UPF on-board, in accordance with some aspects.

Like in scenario 1, this solution also requires the exposure of the N2 and N4 interface over a satellite link (see FIG. 7), leading to higher control plane latencies compared to a local ethernet connection between RAN, AMF, SMF, and UPF. As for scenario 1, the latency overhead can be addressed by the present disclosure.

The disclosed techniques further include an AI Architecture, which can be used to decide on appropriate handover (H/O) between satellite and terrestrial access in accordance with the European Union Artificial Intelligence Regulation (AI Act).

To mitigate the large propagation delay of control messages (e.g., N4/PFCP, N2/NGAP) when sent over satellite links, the present disclosure proposes latency-aware NF function placement for Edge Computing in satellite backhaul and fronthaul scenarios.

The proposed techniques reduce the amount of control messages sent over the satellite link and, therefore, improve the network performance and user experience.

In the present disclosure, as a background assumption, an edge/MEC system can be deployed in 3GPP networks (from Rel.18 on, i.e., 5G-Advanced) as an evolution of current 5G edge deployments, where it is assumed that a complete alignment between EDGEAPP and ETSI MEC systems are in place. As an example, a converged architecture is assumed. The MEC deployment can be seen thus in the above perspective as outside of the PLMN domain (in the most general case), where in this context, the MEC App is equivalent to an EAS and can consume APIs from the underlying edge platform (MEP/EES). Note that this exemplary assumption is not a limitation, and the remaining two deployment options in the TR can be considered.

### Edge Computing in Satellite Backhaul Scenario 1

The disclosed techniques include latency-aware NF function placement for Edge Computing in satellite backhaul scenarios by leveraging architectural building blocks proposed for (i) dynamic function placement (DFP), (ii) the replacement of the N2 interface with a service-based interface (SBI), and (iii) distributed NAS enabling per NF service signaling.

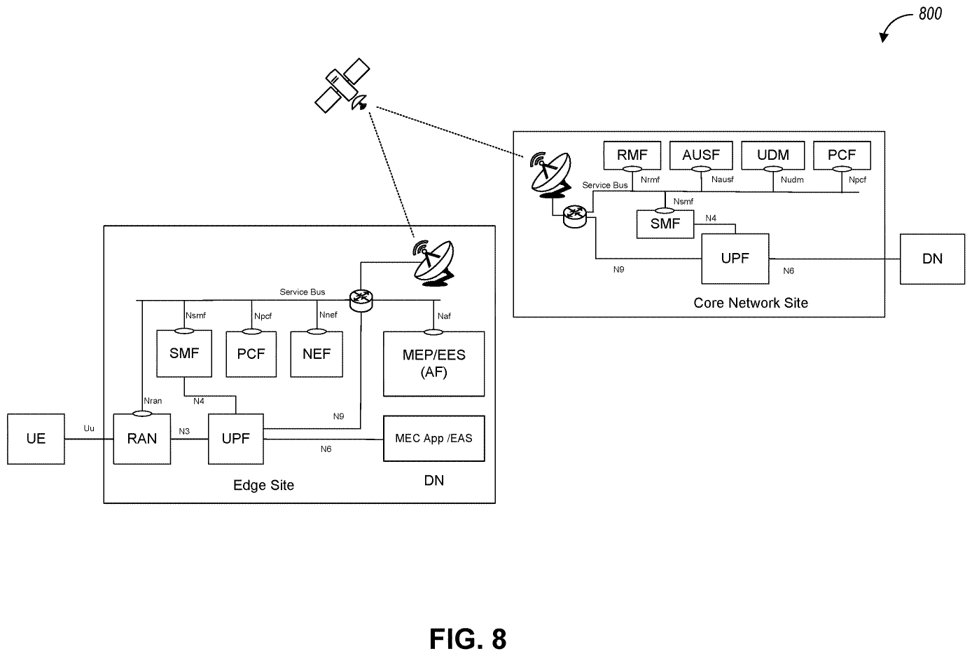

FIG. 8 illustrates an architecture with an SMF included in the edge site.

FIG. 8 illustrates diagram 800 of edge computing with satellite backhaul and latency-aware NF function placement, in accordance with some aspects.

In the architecture illustrated in FIG. 8, the terrestrial RAN is connected to the service bus in the edge network, supporting direct communication between RAN and NFs (e.g., SMF) without relay via AMF. The SMF in the edge network terminates the N4 interface towards the UPF in the edge network to avoid the need to send PFCP messages over the satellite link. The SMF in the core network terminates the N4 interface towards the UPF in the core network. While the AMF is no longer involved in forwarding messages between RAN and CN, its remaining functionality for registration and mobility management is moved into the newly introduced Registration and Mobility Management network function (RMF). Here, the edge services consumption from MEC Platform (MEP)/EES (Edge Enabler Server) can also be allowed as usual by means of service exposure via NEF. Note that both EAS and EES (and their counterparts in ETSI MEC architecture, i.e., MEC Application and MEC platform) may reside outside the PLMN domain. Practically, in some cases, they can be physically placed in the same edge PoP (point-of-presence) but run over different NFVI infrastructures. Finally, the MEC orchestrator (not shown in the figure for simplicity) is a 5G AF and interacts with NEF and with other relevant NFs with regard to overall Monitoring, Provisioning, Policy, and Charging capabilities. The MEC orchestrator can be typically deployed in a more centralized location, i.e., on the right side of the FIG. 8.

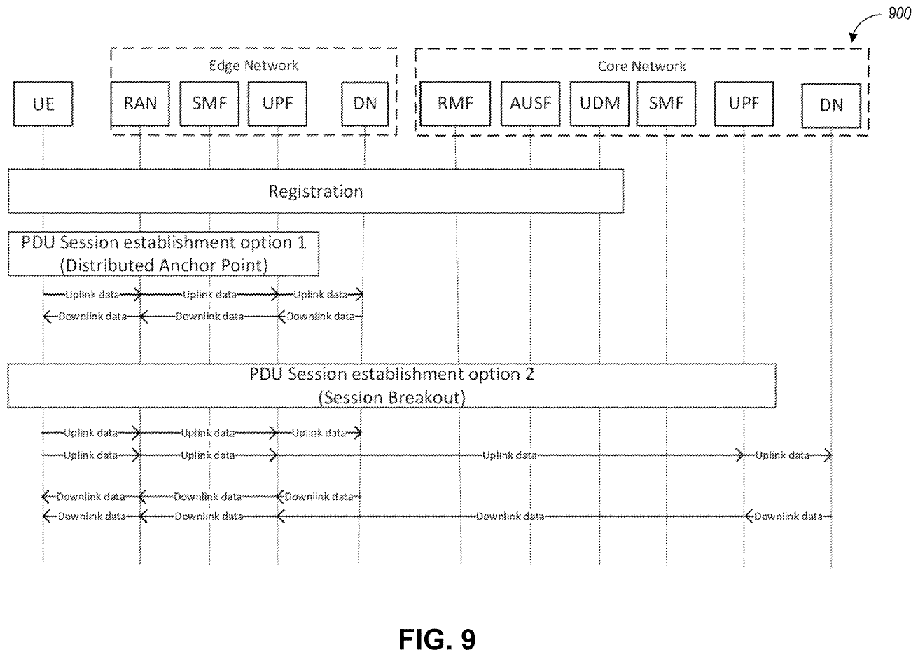

FIG. 9 specifies the registration and PDU session procedure supporting latency-aware NF function placement.

FIG. 9 illustrates diagram 900 of the registration and PDU session establishment procedure, in accordance with some aspects.

In FIG. 9, the registration procedure is anchored in the RMF. The new functional split between RAN and RMF is optimized for latency by reducing the amount of control messages sent over the satellite link.

The PDU session procedure supports two options. Option 1 uses a distributed anchor point with the UPF PSA and DN in the edge network. In this option, the PDU session is anchored in the SMF of the edge network. Due to the distributed NAS, direct communication between RAN and SMF is supported, and accordingly, the number of control messages sent over the satellite link is vastly reduced.

Option 2 uses session breakout with multiple UPF PSAs in the edge network and core network. In this option, the PDU session has anchors in the SMF of the edge network and the SMF of the core network. Both the SMFs act as a single logical SMF. The functional split between the edge network SMF and the core network SMF is optimized for latency by reducing the amount of control messages sent over the satellite link.

### Scenario 1-Bis

As a variant of scenario 1, an alternative embodiment can consider deploying the NEF in the Core Network site (right side of FIG. 8).

In some aspects, in both cases (scenario 1 and 1-bis), the RMF can support not only the latency-aware placement of NFs but also smart AF function placement (in alignment with NEF and NRF, as per 3GPP specifications).

### Edge Computing in Satellite Fronthaul Scenario 2

This scenario is based on 3GPP TR 23.700-27, where UPF is deployed on the GEO satellite with gNB on board. The disclosed techniques can be based on exposing the N2 and N4 interface over a satellite link (feeder link), which has issues as outlined above. To mitigate those issues, latency-aware NF function placement for Edge Computing in satellite fronthaul scenarios is proposed by leveraging architectural building blocks for (i) dynamic function placement (DFP), (ii) the replacement of the N2 interface with a service-based interface (SBI), and (iii) distributed NAS enabling per NF service signaling.

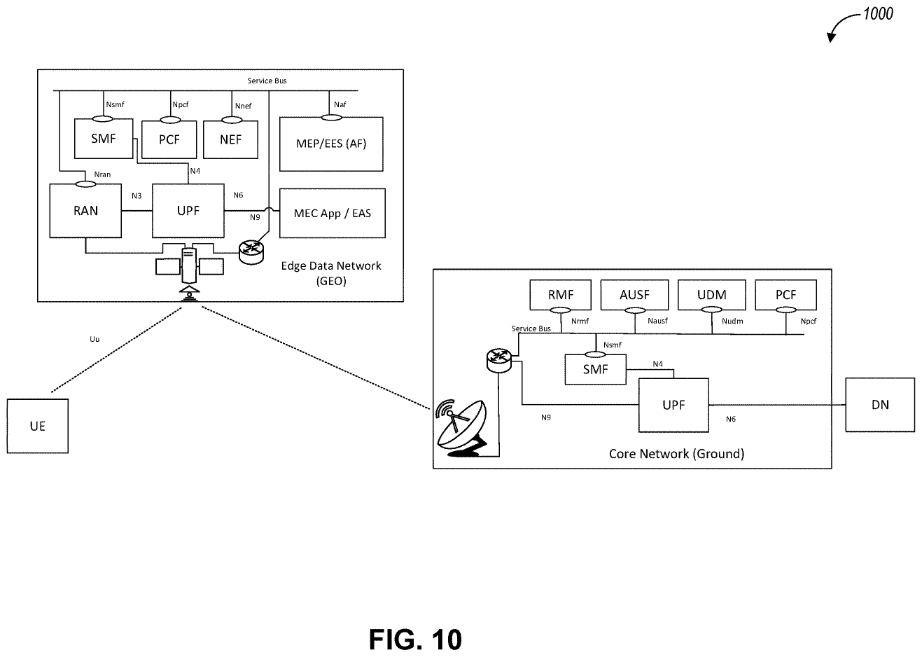

FIG. 10 illustrates an architecture with an SMF included in the edge network onboard the satellite.

FIG. 10 illustrates diagram 1000 of satellite edge computing with latency-aware NF function placement, in accordance with some aspects.

In FIG. 10, the satellite RAN is connected to the service bus of the on-board edge network, supporting direct communication between RAN and NFs (e.g., SMF). Like in FIG. 8, the SMF in the edge network terminates the N4 interface towards the UPF in the edge network to avoid the need to send PFCP messages over the satellite link. The SMF in the core network terminates the N4 interface towards the UPF in the core network. As in FIG. 8, the AMF is no longer involved in forwarding messages between RAN and CN, and its remaining functionality for registration and mobility management is moved to the new Registration and Mobility Management network function (RMF). Also, here, the edge services consumptions from MEC Platform (MEP)/EES (Edge Enabler Server) can be allowed as usual by means of service exposure via NEF. In some aspects, both EAS and EES (and their counterparts in ETSI MEC architecture, i.e., MEC Application and MEC platform) may reside outside the PLMN domain. Practically, in some cases, they can be physically placed in the same edge PoP (point-of-presence) but run over different NFVI infrastructures. Finally, the MEC orchestrator (not shown in the figure for simplicity) is a 5G AF and interacts with NEF and with other relevant NFs with regard to overall Monitoring, Provisioning, Policy, and Charging capabilities. The MEC orchestrator can typically be deployed in a more centralized location, i.e., on the right side of FIG. 10.

### Scenario 2-Bis

As a variant of scenario 1, an alternative embodiment can consider deploying the NEF in the Core Network site (right side of FIG. 10).

In some aspects, in both cases (scenarios 2 and 2-bis), the RMF can support not only the latency-aware placement of NFs but also smart AF function placement (in alignment with NEF and NRF, as per 3GPP specifications).

### AI-Based Selection Between Terrestrial and Satellite Access

In some aspects, the disclosed techniques can include an AI Architecture configured in accordance with the European Regulation “Proposal for a REGULATION OF THE EUROPEAN PARLIAMENT AND OF THE COUNCIL LAYING DOWN HARMONISED RULES ON ARTIFICIAL INTELLIGENCE (ARTIFICIAL INTELLIGENCE ACT) AND AMENDING CERTAIN UNION LEGISLATIVE ACTS, April 2021” (Draft AI Act).

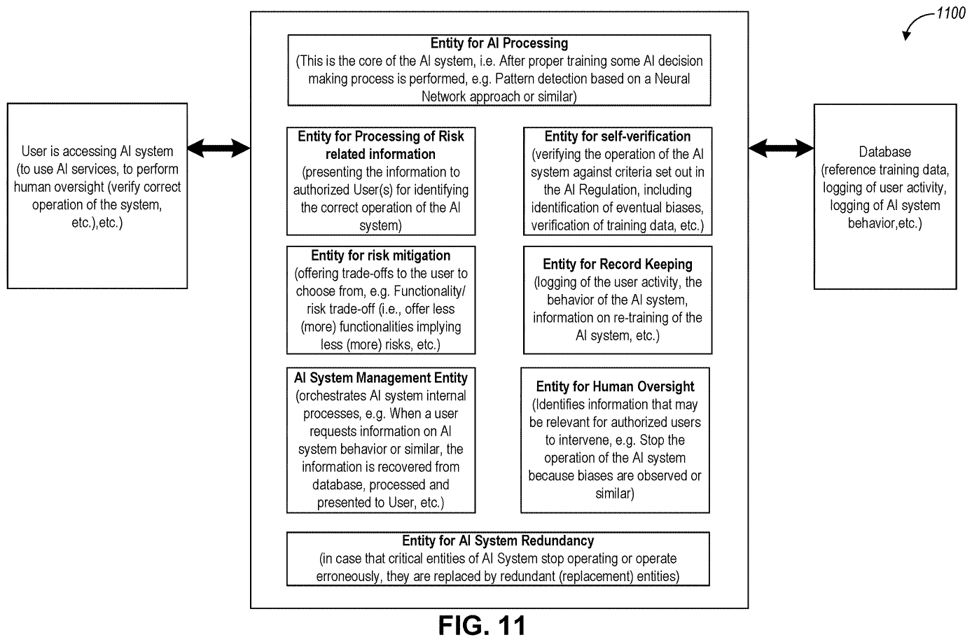

FIG. 11 illustrates diagram 1100 of an AI system architecture in accordance with the European (Draft) AI Act., in accordance with some aspects.

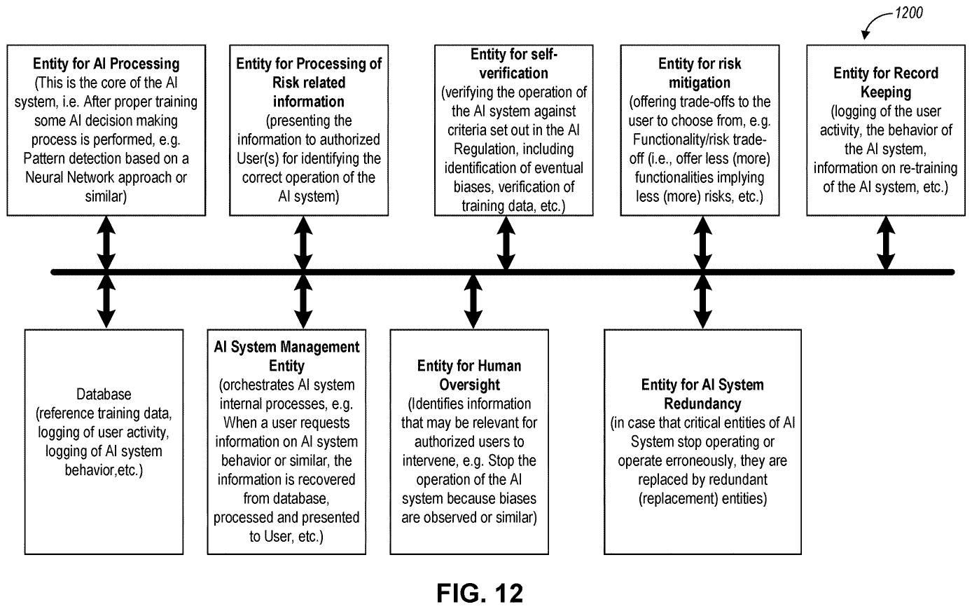

In the proposed AI architecture, the entities introduced above are interconnected through a bus, as illustrated in FIG. 12.

FIG. 12 illustrates diagram 1200 of a functional architecture interconnecting entities of an AI system architecture through a bus., in accordance with some aspects.

The interactions between the various entities of the AI Architecture depend on the specific use cases. Key examples are given below:
(a) Interactions of entities of AI Architecture: Avoidance of undesired biases.

A key requirement of the European AI Act relates to the avoidance of undesired biases. The problem statement is evident in applications such as biometric identification of physical persons. The applicable AI model must rely on training data that is representative and includes sufficient references to physical persons of various characteristics and origins. Specifically, it is not acceptable to base the training of an AI model exclusively on a small number of persons belonging to one ethnic group (or a small number of distinct ethnic groups). Instead, a large representative training data set that appropriately addresses the target audience needs to be applied.

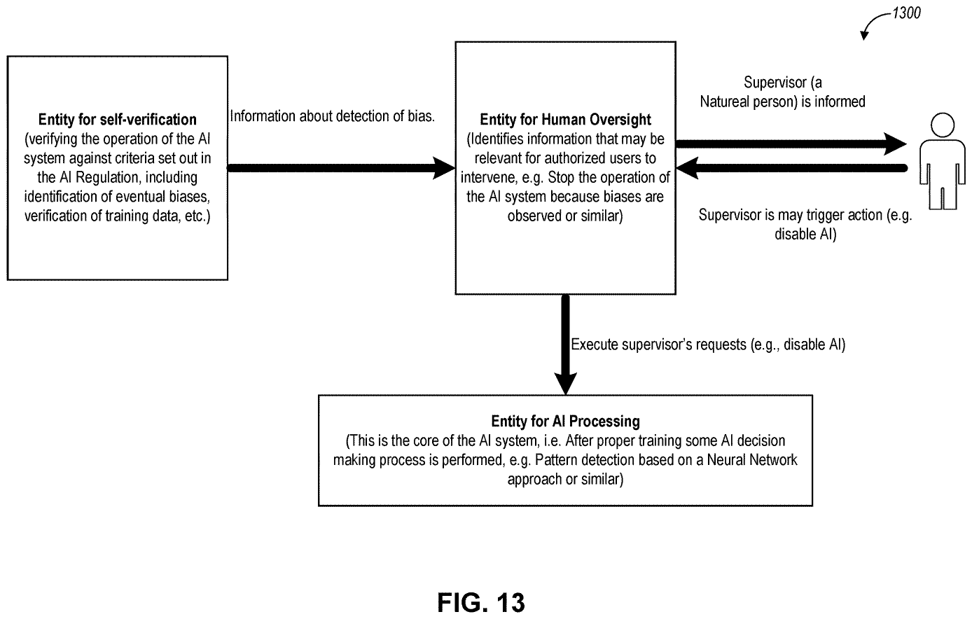

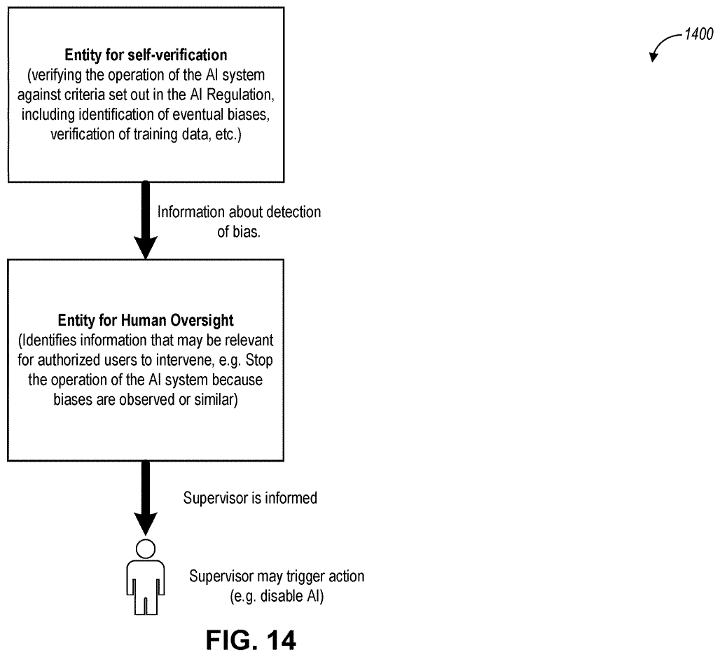

Once the AI system is trained, its database is typically further extended by using ongoing observations. The AI model is constantly improved and refined, exploiting such ongoing observations. Care must be taken in order to avoid any undesired biases being developed. For this purpose, an interaction between the following entities of the AI System is applied as illustrated in FIG. 13 (and in FIG. 14 in a simplified way).

FIG. 13 illustrates diagram 1300 of interactions of entities of an AI architecture in connection with the avoidance of undesired biases, in accordance with some aspects.

FIG. 14 illustrates a simplified diagram 1400 of interactions of entities of an AI architecture in connection with the avoidance of undesired biases, in accordance with some aspects.

The “Entity for self-verification” is constantly monitoring the AI system and verifying whether the update of the AI model may lead to undesired biases (for example, through applying validation example data sets in order to verify that all ethnic groups are handled equally). The corresponding assessment is communicated by the “Entity for Self-verification” to the “Entity for Human Oversight.” The “Entity for Human Oversight” extracts the most relevant information and makes it available to a human supervisor (typically through appropriate graphical representation, an indication of the most critical numerical metric (for example, the detection probability for various ethnic groups, etc.), etc. The human supervisor will then decide whether any specific action needs to be taken, for example, the retraining of the AI System, fallback to an initial AI model, fallback to a previous AI model before any undesired bias was detected, etc. The human supervisor communicates his decisions and actions to the “Entity for Human Oversight,” which then initiates the corresponding actions through interaction with the relevant entities, typically with the “Entity for AI processing” (and possibly further entities of the AI System).
(b) Interactions of entities of AI Architecture: Management of AI System Redundancy.

Critical components/entities of an AI System require redundancy, i.e., in case a critical component/entity is failing or misbehaving (i.e., not behaving according to expectation, for example, leading to physical harm of persons, violating fundamental rights or EU values, etc.), the AI System must be able to replace that failing component/entity.

The basic process is as follows: The “Entity for self-verification” is constantly monitoring the AI system and is verifying whether all components/entities are operating appropriately; specific attention is given to “critical” components/entities (i.e., the verification frequency is higher for critical systems compared to other components/entities, the correct operation is verified in greater depths by observing a larger number of metrics over a longer period of time compared to other components/entities). In case an issue is identified for a “critical” component/entity, the “Entity for AI System Redundancy” is triggered, and a replacement of the failing/misbehaving component/entity is initiated. The “Entity for AI System Redundancy” is interacting with any other required AI System entity in order to reconfigure the system to take the new configuration into account.

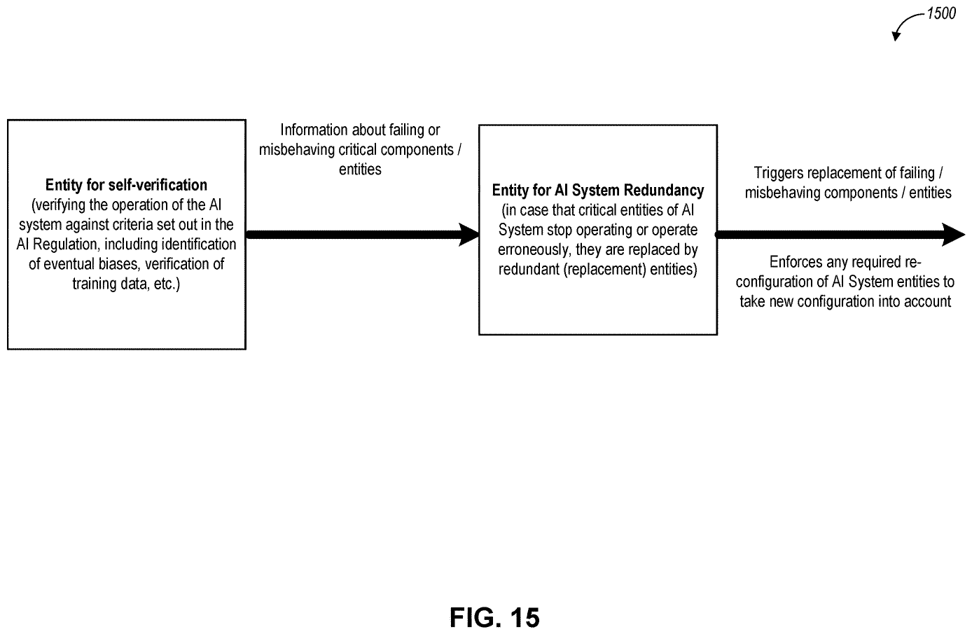

FIG. 15 illustrates diagram 1500 interactions of entities of an AI architecture in connection with the replacement of failing/misbehaving components/entities, in accordance with some aspects.

The AI System can be used in order to support a user to efficiently switch between Satellite and Terrestrial communication. The following process can be applied:
(a) A database is fed with a number of observations when a user typically switches from Satellite Access to Terrestrial Access and vice versa. For each of those observations, the context information is also stored, including the geographic location of users, movement speed, movement direction, type of data usage (e.g., voice, internet access, etc.), etc.
(b) An AI model is derived based on the observations—typically, a deep neural network is being trained taken as input: the type of access of a user (Satellite, Terrestrial, etc.) and the context (geographic location of users, movement speed, movement direction, type of data usage (e.g., voice, internet access, etc.), etc.). As a result, the deep neural network will provide a recommendation on whether a H/O should be executed and—if yes—to which access type (typically Satellite, Terrestrial, or other).
(c) The AI model is constantly updated based on the observations of the concerned user.

The disclosed techniques can be used to configure a cellular network providing data connectivity to a UE. In some aspects, a satellite backhaul is used between the core and the terrestrial access network (see scenario 1). In some aspects, a satellite access network supporting gNB-processed payload is used (see scenario 2). In some aspects, edge computing is supported using an edge network collocated with the access network. In some aspects, the UPF and its controlling SMF are both located in the edge network. In some aspects, direct communication between RAN and NFs (e.g., SMF) is supported without relaying the communication via AMF. In some aspects, the legacy AMF functionality for registration and mobility management is moved to the new Registration and Mobility Management network function (RMF). In some aspects, the registration procedure is anchored in RMF, and the functional split between RAN and RMF is optimized for latency by reducing the amount of control messages sent over the satellite link.

In some aspects, the PDU session procedure supports a distributed anchor point with the UPF PSA and DN in the edge network. In some aspects, the number of control messages sent over the satellite link is largely reduced by anchoring the PDU session in the SMF of the edge network. In some aspects, the PDU session procedure supports session breakout with multiple UPF PSAs in the edge network and core network. In some aspects, the PDU session has anchors in the SMF of the edge network and in the SMF of the core network. In some aspects, both the SMFs act as a single logical SMF where the functional split between the edge network SMF and the core network SMF is optimized for latency by reducing the amount of control messages sent over the satellite link. In some aspects, the EES/MEP (MEC Platform) offers services to the EAS/MEC Application. In some aspects, the MEC orchestrator as a 5G AF interacts with NEF and with other relevant NFs with regard to overall Monitoring, Provisioning, Policy, and Charging capabilities.

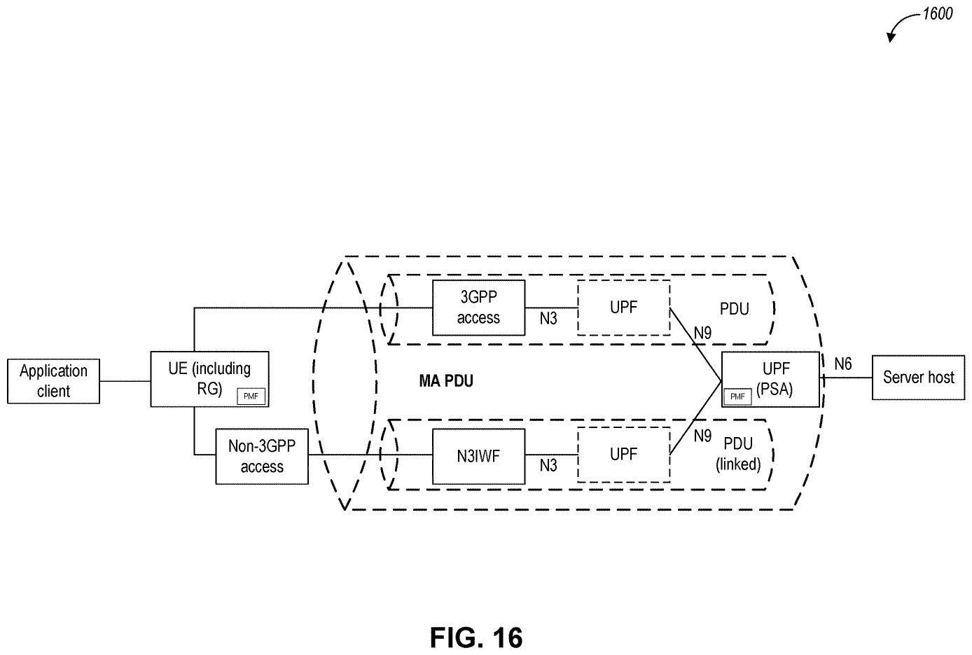

FIG. 16 illustrates a diagram 1600 of Access Traffic Steering, Switch, and Splitting (ATSSS) support in a 5G system architecture, in accordance with some aspects.

Programmable data planes are expected to enable the rapid development of new network functionality. In some aspects, networks can become programmable by introducing NIC, routers, and switches supporting network programming (e.g., based on the P4 programming language).

The disclosed techniques include solutions to improve existing 5GS performance measurement and packet processing functionality by leveraging the P4 programming language. The 3GPP Release 17 work item Access Traffic Steering, Switch, and Splitting (ATSSS) can be used as a baseline for the proposed enhancements. However, the proposed enhancements are generic and can be reused for other use cases, including redundant transmission for high-reliability communication as specified in 3GPP TS 23.501 clause 5.33.2.

In some aspects, ATSSS introduces a Multi-Access PDU (MA PDU) Connectivity Service, which can exchange PDUs between the UE and a data network by simultaneously using one 3GPP access network and one non-3GPP access network with two independent N3/N9 tunnels between the UPF PDU Session Anchor (UPF PSA) and the access networks.

Based on network-provided policy and local conditions (such as network interface availability, signal loss conditions, user preferences, etc.), the UE decides how to distribute the uplink traffic across the two access networks. Similarly, the UPF PSA based on network-provided policy (i.e., N4 rules derived by UE's serving SMF based on ATSSS policy from serving PCF) and the feedback information received from the UE via the user-plane (such as access network Unavailability or Availability), the UPF then decides how to distribute the downlink traffic across the two N3/N9 tunnels and the two access networks.

ATSSS specifies the usage of MPTCP or ATSSS-LL as supported steering functionality. ATSSS-LL specifies a Performance Measurement Function (PMF) in the UE and the UPF PSA, as shown in FIG. 16 supporting Round-Trip-Time (RTT) and Packet Loss Rate (PLR) measurements per access between UE and UPF PSA. PMF measurements are per QoS Flow and can be used to decide how to steer the traffic of a specific data flow.

However, the available solution in 3GPP Rel-17 for Round-Trip-Time (RTT) and Packet Loss Rate (PLR) measurements requires additional control packets (in addition to user data packets) to be exchanged over the access network. This has the following drawbacks:
(a) Creates an overhead in the number of data to be exchanged over the access network.
(b) Provides potentially inaccurate RTT measurement as the additional control packets may observe different processing delays compared to the actual user data packets.

Furthermore, the intermediate network devices (switches and routers not shown in FIG. 16) processing the N3/N9 traffic typically perform packet processing prioritization purely based on the DSCP value in the GTP-U outer IP header where the access network or UPF derives the DSCP value from the configures quality of service (QoS) Flow information and sets this value for all packets associated with the QoS Flow. This has the following drawbacks:
(c) Packet processing priority handling based only on static values may result in a rigid forwarding performance that is not able to adjust to the varying network conditions dynamically.

The proposed techniques reduce the data overhead in the access network, allow for more accurate round-trip time measurement, and support adaptive packet processing priority handling, thereby improving network performance and user experience. This will result in an increased proliferation of 6GS and programmable network devices.

The disclosed techniques include an advanced ATSSS solution to mitigate the issues outlined above by leveraging end-to-end programmability for the collection and reporting of network states (using In-band Network Telemetry (INT) and for performing changes to traffic engineering and packet forwarding.

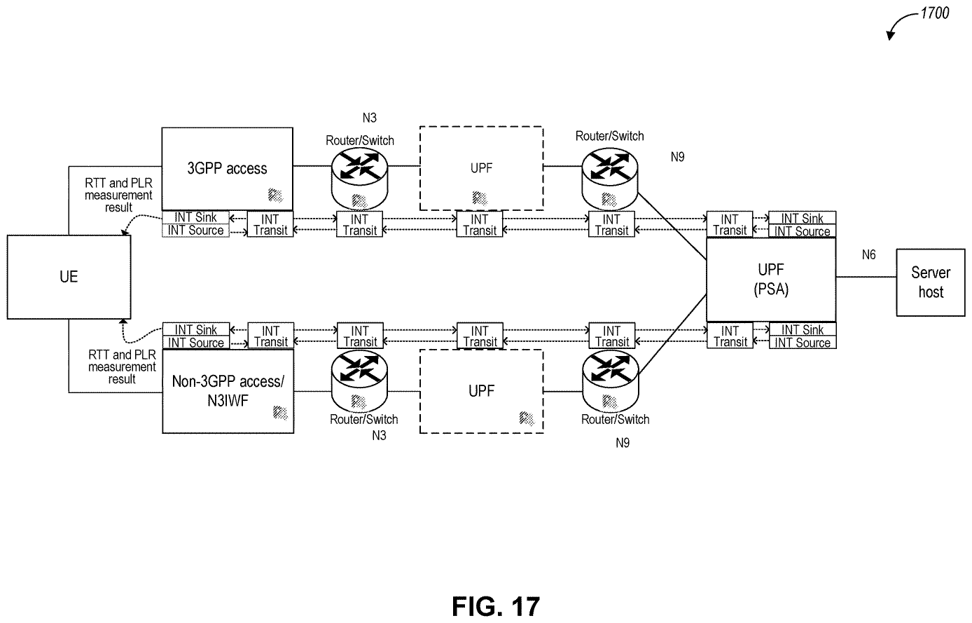

FIG. 17 illustrates diagram 1700 of an advanced ATSSS architecture supporting end-to-end network programmability, in accordance with some aspects.

FIG. 17 illustrates an advanced ATSSS architecture where the participating network devices support end-to-end network programmability based on P4.

The disclosed techniques described below include solutions for supporting (i) enhanced performance measurement using INT and (ii) adaptive packet processing priority handling leveraging P4-based network programmability.

### Enhanced Performance Measurements Using INT

In 3GPP Release 17, the ATSSS-LL feature specifies the exchange of PMF-Echo Request and Response messages for RTT measurements. The UE and the UPF initiate the measurement independently by sending a PMF-Echo Request over a specific access leg. The RTT delay is estimated based on the time until the initiator receives a PMF-Echo Response messages over the same access leg. This solution creates an overhead as it requires the exchange of dedicated control packets in addition to the user data packets. There is also a potential issue that the estimated RTT measurement is inaccurate as those control packets may observe different processing delays compared to the actual user data packets.

Furthermore, for measuring the packet loss rate (PLR), the 3GPP Release 17 ATSSS-LL feature specifies the exchange of PMFP PLR request/response messages. The UE and the UPF initiate the measurement independently by sending a PMFP PLR count request message. The receiving UPF or UE starts counting the received packets until a PMFP PLR report request message is received and then sends a report in a response message. The initiating UE or UPF calculates the PLR based on the amount of sent and successfully received packets. Again, this solution creates an overhead as it requires the exchange of dedicated control packets in addition to the user data packets.

To mitigate the issues outlined above, the disclosed techniques include INT-based performance measurements in 6G. INT supports tracking packets through a network by inserting an INT header with instructions to collect network state metadata into the packet as it traverses the network. To measure and report latency, an INT source embeds instructions for packets to collect the time stamp of the local egress and local ingress to report the difference in the latency for that network element. The receiving INT transit device can compute the end-to-end latency as a sum of the per-hop latencies. Per-hop latencies in the packet received at the INT transit can also be used to determine which network element(s) contributed most to the end-to-end latency.

Specific to the ATSSS-LL RTT performance measurement as specified in FIG. 17, the disclosed techniques include mimicking the PMF-Echo Request/Response procedure using INT. For uplink and downlink packets, the access network collects metadata of the UE-AN interface (e.g., the packet delay and PLR observed over the radio link) in the role of an INT transit device. In addition to the standard INT behavior to enable PLR measurements, it is proposed to enhance INT with additional instructions to request the counting of received packets associated with a specific QoS flow identified by the QFI available in the INT header. Furthermore, the performance information collected at the INT sink needs to be mirrored back to the INT source to allow the initiator to consider the performance measurement result for the packet steering decision. For example, the handling of the standard INT Report packet can be extended to support the computation of the link latencies. In some aspects, the Report traffic packet is recirculated in the backward direction up to the INT source (the initiator of the measurement). In addition, to support the proposed architecture in FIG. 17 where the INT source/sink is in the access network, the performance measurement result can be exposed to the UE as needed by the steering logic in the UE. This can be done via a new access network exposure service (e.g., by extending the RRC protocol).

### Adaptive Packet Processing Priority Handling

In today's 5GS deployments, transport level packet marking on a per QoS Flow basis can be supported by the RAN and UPF on the N3 and N9 interface in case the underlying transport is using QoS differentiation. Typically, the packet processing in the transport network uses the 6-bit DSCP value in the GTP-U outer IP header for packet prioritization. However, limiting the packet processing priority handling of a specific packet of a specific QoS flow to a static value will result in a rigid forwarding performance that is not able to adjust to the varying network conditions dynamically. For example, the delay of a specific packet may accumulate (e.g., due to re-transmissions in RAN and network congestion) to a point where the packet is dropped at the receiver.

In 6G, In-band telemetry (INT) can be configured with additional QoS-related instructions derived from the associated QoS flow requirements and included in some or all packets (packet selection can be based on specific QoS requirements and/or network conditions). In FIG. 17, for uplink data, an INT header with QoS-related instructions is inserted by the access network (INT source) following the GTP-U outer TCP/UDP header and removed by the UPF PSA (INT sink) before forwarding a packet over the N6 interface. Likewise, for downlink packets, the UPF PSA (INT source) inserts an INT header with QoS-related instructions following the GTP-U outer TCP/IP header, and the access network removes the INT header with the QoS-related instructions before forwarding a packet to the UE.

For example, the INT header can include a new instruction to enforce a packet latency deadline (maximum allowed end-to-end latency). The latency deadline is derived from the associated QoS flow requirement and included in the INT header or metadata by the access network (for uplink data) and the UPF (for downlink data). In the uplink and downlink path, the network devices are then programmed (e.g., by an SDN controller) to enforce prioritized packet processing based on the packet latency deadline (considering the latency of any previous hop) and to update the INT metadata with the observed hop latency. The INT sink decides whether to report the collected information (e.g., to the SDN controller).

The disclosed techniques can be used to configure a cellular network providing data connectivity to a UE. In some aspects, some or all network devices participating in the user plane support end-to-end network programmability (e.g., based on P4). In some aspects, the access network (when processing uplink packets) and the UPF PSA (when processing downlink packets) act in the role of an INT source and append the outer header of the N3/N9 encapsulation protocol (e.g., GTP-U) with an INT header. In some aspects, the access network (when processing downlink packets) and the UPF PSA (when processing uplink packets) act in the role of an INT sink and remove the INT header together with the outer header of the N3/N9 encapsulation protocol (e.g., GTP-U). In some aspects, for uplink and downlink packets, the access network collects metadata of the UE-AN interface (e.g., the packet delay and PLR observed over the radio link) in the role of an INT transit device. In some aspects, one or more network devices (when processing uplink or downlink packets) act in the role of an INT transit device. In some aspects, the access network and/or the UPF PSA and/or any network device supports RTT and PLR measurements using INT.

In some aspects, to enable PLR measurements, it is proposed to enhance INT with additional instructions to request the counting of received packets associated with a specific QoS flow identified by the QFI available in the INT header. In some aspects, the performance information collected at the INT sink is mirrored back to the INT source to allow the initiator to consider the performance measurements. In some aspects, the access network and/or any network function exposes a new service to the UE to report RTT and PLR measurement results. In some aspects, the access network and the UPF PSA expose the collected hop latency, RTT, and PLR measurement results to other network functions (e.g., NWDAF, AMF, SMF, OAM, etc.). In some aspects, INT is enhanced to support QoS-related instructions (e.g., to enforce a packet latency deadline, etc.). In some aspects, one or more network device enforces prioritized packet processing based on the packet latency deadline (considering the latency of any previous hop) and to update the INT metadata with the observed hop latency.

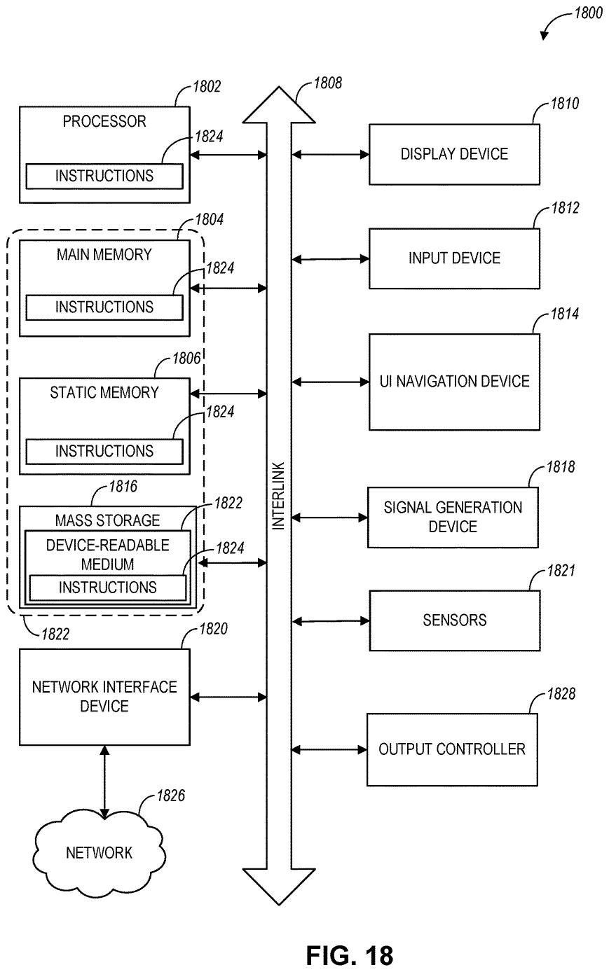

FIG. 18 illustrates a block diagram of a communication device such as an evolved Node-B (eNB), a new generation Node-B (gNB) (or another RAN node such as a base station), a satellite node, a network-controlled repeater (NCR), an access point (AP), a wireless station (STA), a mobile station (MS), or user equipment (UE), in accordance with some aspects and to perform one or more of the techniques disclosed herein. In alternative aspects, the communication device 1800 may operate as a standalone device or may be connected (e.g., networked) to other communication devices.

Circuitry (e.g., processing circuitry) is a collection of circuits implemented in tangible entities of the device 1800 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in the first circuit of a first circuitry at one point in time and reused by a second circuit in the first circuitry, or by a third circuit in a second circuitry at a different time. Additional examples of these components with respect to the device 1800 follow.

In some aspects, the device 1800 may operate as a standalone device or may be connected (e.g., networked) to other devices. In a networked deployment, the communication device 1800 may operate in the capacity of a server communication device, a client communication device, or both in server-client network environments. In an example, the communication device 1800 may act as a peer communication device in a peer-to-peer (P2P) (or other distributed) network environment. The communication device 1800 may be a UE, eNB, PC, a tablet PC, STB, PDA, mobile telephone, smartphone, a web appliance, network router, a switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules needs not to be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 1800 may include a hardware processor 1802 (e.g., a central processing unit (CPU), a graphics processing unit (GPU), a hardware processor core, or any combination thereof), a main memory 1804, a static memory 1806, and a storage device 1816 (e.g., hard drive, tape drive, flash storage, or other block or storage devices), some or all of which may communicate with each other via an interlink 1808 (e.g., a bus).

The communication device 1800 may further include a display device 1810, an input device 1812 (e.g., a keyboard), and a user interface (UI) navigation device 1814 (e.g., a mouse). In an example, the display device 1810, input device 1812, and UI navigation device 1814 may be a touchscreen display. The communication device 1800 may additionally include a signal generation device 1818 (e.g., a speaker), a network interface device 1820, and one or more sensors 1821, such as a global positioning system (GPS) sensor, compass, accelerometer, or another sensor. The communication device 1800 may include an output controller 1828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1816 may include a device-readable medium 1822, on which is stored one or more sets of data structures or instructions 1824 (e.g., software) embodying or utilized by any one or more of the techniques or functions described herein. In some aspects, registers of the hardware processor 1802, the main memory 1804, the static memory 1806, and/or the storage device 1816 may be, or include (entirely or at least partially), the device-readable medium 1822, on which is stored the one or more sets of data structures or instructions 1824, embodying or utilized by any one or more of the techniques or functions described herein. In an example, one or any combination of the hardware processor 1802, the main memory 1804, the static memory 1806, or the storage device 1816 may constitute the device-readable medium 1822.

As used herein, the term “device-readable medium” is interchangeable with “computer-readable medium” or “machine-readable medium”. While the device-readable medium 1822 is illustrated as a single medium, the term “communication device-readable medium” may include a single medium or multiple media (e.g., a centralized or distributed database and associated caches and servers) configured to store the instructions 1824. The term “communication device-readable medium” is inclusive of the terms “machine-readable medium” or “computer-readable medium” and may include any medium that is capable of storing, encoding, or carrying instructions (e.g., instructions 1824) for execution by the communication device 1800 and that causes the communication device 1800 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

Instructions 1824 may further be transmitted or received over a communications network 1826 using a transmission medium via the network interface device 1820 utilizing any one of several transfer protocols. In an example, the network interface device 1820 may include one or more physical jacks (e.g., Ethernet, coaxial, or phone jacks) or one or more antennas to connect to the communications network 1826. In an example, the network interface device 1820 may include a plurality of antennas to wirelessly communicate using at least one of the single-input-multiple-output (SIMO), MIMO, or multiple-input-single-output (MISO) techniques. In some examples, the network interface device 1820 may wirelessly communicate using Multiple User MIMO techniques.

The term “transmission medium” shall be taken to include any intangible medium that is capable of storing, encoding, or carrying instructions for execution by the communication device 1800 and includes digital or analog communications signals or another intangible medium to facilitate communication of such software. In this regard, a transmission medium in the context of this disclosure is a device-readable medium.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Described implementations of the subject matter can include one or more features, alone or in combination, as illustrated below by way of examples.

Example 1 is an apparatus for a network function (NF) node configured for operation in a Sixth Generation (6G) and beyond network, the apparatus comprising processing circuitry, wherein to configure the NF for communication with a core network in the 6G and beyond network, the processing circuitry is to: decode uplink (UL) data received at a user plane function (UPF) of the NF node from a radio access network (RAN), the UL data originating from a user equipment (UE) in communication with the RAN; encode the UL data for retransmission to a core network of the 6G and beyond network via a satellite communication link; and decode downlink (DL) data received from a UPF of the core network via the satellite communication link in response to the retransmission of the UL data, the DL data originating from a data network of the core network; and a memory coupled to the processing circuitry and configured to store the UL data and the DL data.

In Example 2, the subject matter of Example 1 includes a 6G and beyond network.

In Example 3, the subject matter of Example 2 includes subject matter where the RAN is configured within the edge network.

In Example 4, the subject matter of Example 3 includes subject matter where the processing circuitry is to decode the UL data received at the UPF of the NF node via an N3 interface with the RAN and without relaying the UL data via an access and mobility management function (AMF).

In Example 5, the subject matter of Examples 2-4 includes subject matter where the processing circuitry is to perform a registration of the UPF and a session management function (SMF) of the NF node with a Registration and Mobility Management network function (RMF) prior to the retransmission of the UL data.

In Example 6, the subject matter of Example 5 includes subject matter where the RMF is configured within the core network.

In Example 7, the subject matter of Examples 5-6 includes subject matter where the SMF is collocated with the RAN within the edge network and wherein the RAN is in direct communication with the SMF via a service bus interface (SBI) of the edge network.

In Example 8, the subject matter of Example 7 includes subject matter where the RAN is further collocated with an artificial intelligence (AI) architecture accessible by the UE and by the core network.

In Example 9, the subject matter of Example 8 includes subject matter where the AI architecture comprises a plurality of AI-based functions coupled to a common bus, the plurality of AI-based functions comprising an AI processing function, a self-verification function, a risk mitigation function, a record-keeping function, a risk-related information processing function, an AI system management function, a human oversight function, and an AI system redundancy function.

In Example 10, the subject matter of Examples 1-9 includes transceiver circuitry coupled to the processing circuitry; and one or more antennas coupled to the transceiver circuitry.

Example 11 is a computer-readable storage medium that stores instructions for execution by one or more processors of user equipment (UE), the instructions to cause the UE to perform operations comprising encoding a first protocol data unit (PDU) for transmission to a user plane function PDU Session Anchor (UPF PSA) via a first communication interface tunnel of a first access network, the UPF PSA associated with a data network; and encoding a second PDU for transmission to the UPF PSA via a second communication interface tunnel of a second access network.

In Example 12, the subject matter of Example 11 includes subject matter where the first access network and the second access network are configured as In-band Network Telemetry (INT) source and append an outer header of a N3/N9 encapsulation protocol of the first PDU and the second PDU with a first INT header; and the UPF PSA is configured to append an outer header of a N3/N9 encapsulation protocol of a third PDU including downlink information with a second INT header, the second INT header based on the first INT header.

In Example 13, the subject matter of Example 12 includes the operations further comprising performing Round-Trip-Time (RTT) and Packet Loss Rate (PLR) measurements associated with the first communication interface tunnel and the second communication interface tunnel based on the second INT header.

Example 14 is a computer-readable storage medium that stores instructions for execution by one or more processors of a network function (NF) node, the instructions to configure the NF node for communication with a core network in a Sixth Generation (6G) and beyond network, and to cause the NF node to perform operations comprising: decoding uplink (UL) data received at a user plane function (UPF) of the NF node from a radio access network (RAN), the UL data originating from a user equipment (UE) in communication with the RAN; encoding the UL data for retransmission to a core network of the 6G and beyond network via a satellite communication link; and decoding downlink (DL) data received from a UPF of the core network via the satellite communication link in response to the retransmission of the UL data, the DL data originating from a data network of the core network.

In Example 15, the subject matter of Example 14 includes G and beyond network.

In Example 16, the subject matter of Example 15 includes subject matter where the RAN is configured within the edge network.

In Example 17, the subject matter of Example 16 includes the operations further comprising decoding the UL data received at the UPF of the NF node via an N3 interface with the RAN and without relaying the UL data via an access and mobility management function (AMF).

In Example 18, the subject matter of Examples 15-17 includes the operations further comprising: perform a registration of the UPF and a session management function (SMF) of the NF node with a Registration and Mobility Management network function (RMF) prior to the retransmission of the UL data.

In Example 19, the subject matter of Example 18 includes subject matter where the RMF is configured within the core network.

In Example 20, the subject matter of Examples 18-19 includes subject matter where the SMF is collocated with the RAN within the edge network, wherein the RAN is in direct communication with the SMF via a service bus interface (SBI) of the edge network, and wherein the RAN is further collocated with an artificial intelligence (AI) architecture accessible by the UE and by the core network.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

Although an aspect has been described concerning specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

1. An apparatus for a network function (NF) node configured for operation in a Sixth Generation (6G) and beyond network, the apparatus comprising:
processing circuitry, wherein to configure the NF for communication with a core network in the 6G and beyond network, the processing circuitry is to:
decode uplink (UL) data received at a user plane function (UPF) of the NF node from a radio access network (RAN), the UL data originating from a user equipment (UE) in communication with the RAN;
encode the UL data for retransmission to a core network of the 6G and beyond network via a satellite communication link; and
decode downlink (DL) data received from a UPF of the core network via the satellite communication link in response to the retransmission of the UL data, the DL data originating from a data network of the core network; and
a memory coupled to the processing circuitry and configured to store the UL data and the DL data.

2. The apparatus of claim 1, wherein the NF node is configured within an edge network of the 6G and beyond network.

3. The apparatus of claim 2, wherein the RAN is configured within the edge network.

4. The apparatus of claim 3, wherein the processing circuitry is to:
decode the UL data received at the UPF of the NF node via a N3 interface with the RAN and without relaying the UL data via an access and mobility management function (AMF).

5. The apparatus of claim 2, wherein the processing circuitry is to:
perform a registration of the UPF and a session management function (SMF) of the NF node with a Registration and Mobility Management network function (RMF) prior to the retransmission of the UL data.

6. The apparatus of claim 5, wherein the RMF is configured within the core network.

7. The apparatus of claim 5, wherein the SMF is collocated with the RAN within the edge network, and wherein the RAN is in direct communication with the SMF via a service bus interface (SBI) of the edge network.

8. The apparatus of claim 7, wherein the RAN is further collocated with an artificial intelligence (AI) architecture accessible by the UE and by the core network.

9. The apparatus of claim 8, wherein the AI architecture comprises a plurality of AI-based functions coupled to a common bus, the plurality of AI-based functions comprising an AI processing function, a self-verification function, a risk mitigation function, a record-keeping function, a risk-related information processing function, an AI system management function, a human oversight function, and an AI system redundancy function.

10. The apparatus of claim 1, further comprising:
transceiver circuitry coupled to the processing circuitry; and
one or more antennas coupled to the transceiver circuitry.

11. A non-transitory computer-readable storage medium that stores instructions for execution by one or more processors of a user equipment (UE), the instructions to cause the UE to perform operations comprising:
encoding a first protocol data unit (PDU) for transmission to a user plane function PDU Session Anchor (UPF PSA) via a first communication interface tunnel of a first access network, the UPF PSA associated with a data network; and
encoding a second PDU for for transmission to the UPF PSA via a second communication interface tunnel of a second access network.

12. The non-transitory computer-readable storage medium of claim 11, wherein:
the first access network and the second access network are configured as In-band Network Telemetry (INT) source and append an outer header of an N3/N9 encapsulation protocol of the first PDU and the second PDU with a first INT header; and
the UPF PSA is configured to append an outer header of a N3/N9 encapsulation protocol of a third PDU including downlink information with a second INT header, the second INT header based on the first INT header.

13. The non-transitory computer-readable storage medium of claim 12, the operations further comprising:
performing Round-Trip-Time (RTT) and Packet Loss Rate (PLR) measurements associated with the first communication interface tunnel and the second communication interface tunnel based on the second INT header.

14. A non-transitory computer-readable storage medium that stores instructions for execution by one or more processors of a network function (NF) node, the instructions to configure the NF node for communication with a core network in a Sixth Generation (6G) and beyond network, and to cause the NF node to perform operations comprising:
decoding uplink (UL) data received at a user plane function (UPF) of the NF node from a radio access network (RAN), the UL data originating from a user equipment (UE) in communication with the RAN;
encoding the UL data for retransmission to a core network of the 6G and beyond network via a satellite communication link; and
decoding downlink (DL) data received from a UPF of the core network via the satellite communication link in response to the retransmission of the UL data, the DL data originating from a data network of the core network.

15. The non-transitory computer-readable storage medium of claim 14, wherein the NF node is configured within an edge network of the 6G and beyond network.

16. The non-transitory computer-readable storage medium of claim 15, wherein the RAN is configured within the edge network.

17. The non-transitory computer-readable storage medium of claim 16, the operations further comprising:
decoding the UL data received at the UPF of the NF node via a N3 interface with the RAN and without relaying the UL data via an access and mobility management function (AMF).

18. The non-transitory computer-readable storage medium of claim 15, the operations further comprising:
perform a registration of the UPF and a session management function (SMF) of the NF node with a Registration and Mobility Management network function (RMF) prior to the retransmission of the UL data.

19. The non-transitory computer-readable storage medium of claim 18, wherein the RMF is configured within the core network.

20. The non-transitory computer-readable storage medium of claim 18, wherein the SMF is collocated with the RAN within the edge network, wherein the RAN is in direct communication with the SMF via a service bus interface (SBI) of the edge network, and wherein the RAN is further collocated with an artificial intelligence (AI) architecture accessible by the UE and by the core network.
